(19) United States
(12) Patent Application Publication
(10) Pub. No.: US 2009/0080019 A1
(43) Pub. Date: Mar. 26, 2009

(54) IMAGE FORMING APPARATUS

(76) Inventor: Katsunori TESHIMA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/205,426

(22) Filed: Sep. 5, 2008

(30) Foreign Application Priority Data
Sep. 26, 2007 (JP) JP2007-250244

(51) Int. Cl. G06F 3/12

(52) U.S. Cl. 358/1.15; 358/1.16

(57) ABSTRACT

An image forming apparatus for storing input image data in a storage device, and executing a print job by reading out the image data from the storage device, including: a temperature acquiring section which obtains the temperature of the storage device; a calculation section which calculates the expected completion time of the print job according to a data writing speed of the storage device at the temperature obtained by the temperature acquiring section; and a notifying section which notifies to a user the expected completion time calculated by the calculation section.

### CROSS REFERENCE TO RELATED APPLICATION

The present application is based on Japanese Patent Application No. 2007-250244 filed with Japanese Patent Office on Sep. 26, 2007, the entire content of which is hereby incorporated by reference.

### BACKGROUND OF THE INVENTION

1. Field of Technology

The present invention relates to an image forming apparatus that stores in a storage device such as a hard disk drive, etc. the image data that has been input, and executes print jobs by reading out image data from that storage device, and in particular, to an image forming apparatus that uses a storage device in which the operating speed is reduced at a temperature outside a specific temperature range.

2. Description of Prior Art

In an apparatus having a built in storage device such as a hard disk drive, etc., there are cases in which a reduction in the operating speed or some functional insufficiency of the storage device at low temperatures or at high temperatures can have a large effect on the performance of the apparatus on the whole.

Because of this, for example, there is an apparatus in which a heating section is provided for heating the storage drive such as a hard disk drive, etc., so that an environment in which the storage device can definitely operate is obtained in a short time (see, for example, Japanese Unexamined Patent Application Publication No. 2004-5812).

Further, there is an apparatus that prevents access to the storage device such as a hard disk drive, etc., at low temperatures or at high temperatures, and carries out temperature management so as to quickly depart the low temperature state or the high temperature state by controlling a fan (see, for example, Japanese Unexamined Patent Application Publication No. 2005-4819).

On the other hand, the hard disk devices of recent years are aiming at high capacities due to high density recording, and when they are used outside the appropriate temperature range, write errors easily occur due to the characteristics of high density recording. In view of this, there are hard disk drives having functions for preventing the occurrence of write errors by measuring the internal temperature, and reducing the data writing speed to below the usual speed when the internal temperature is outside a prescribed temperature range.

In an image forming apparatus using a hard disk drive as an image memory storage device in which the data writing speed is reduced to below the usual speed when the temperature is outside a prescribed temperature range, if the writing speed or the reading speed of the storage device becomes low, as an effect of that, the print speed gets reduced, and the productivity of printing gets reduced. In such a condition, if the user enters print jobs without knowing that the productivity of printing has decreased, more time than can be expected is taken until the job is completed, and the users will be subjected to unexpected inconveniences.

On the other hand, if a heating section is provided that heats the storage device such as a hard disk drive in order to prevent reduction in performance at low temperatures, the cost of the apparatus becomes higher. Further, if access to the storage device is stopped at low or high temperatures, printing cannot be made during that period, and the performance of the apparatus gets substantially reduced.

The present invention was made in view of the above problems and the purpose of the present invention is to provide an image forming apparatus that does not cause unexpected inconveniences to the users even when a longer time is required until a print job is completed due to the reduction in the data writing speed of the storage device.

### SUMMARY

An image forming apparatus reflecting one aspect of the present invention in order to achieve the above purpose is:

An image forming apparatus for storing input image data in a storage device, and executing a print job by reading out the image data from the storage device, comprising: a temperature acquiring section which obtains the temperature of the storage device; a calculation section which calculates the expected completion time of the print job according to a data writing speed of the storage device at the temperature obtained by the temperature acquiring section; and a notifying section which notifies to a user the expected completion time calculated by the calculation section.

A printing section reflecting another aspect of the present invention is:

A printing system comprising a plurality of image forming apparatuses each of which stores input image data in a storage device and executes print jobs by reading out the image data from the storage device; and a printing control apparatus which causes the plurality of image forming apparatuses to execute a single print job by sharing the single print job with the plurality of image forming apparatus, wherein each of the image forming apparatuses comprises: a temperature acquiring section which obtains the temperature of the storage device; a calculation section which calculates the expected completion time of the print job according to a data writing speed of the storage device at the temperature obtained by the temperature acquiring section; and a notifying section which notifies to a user the expected completion time calculated by the calculation section, wherein the printing control apparatus inquires to each of the plurality of image forming apparatuses about the expected completion time in a case of executing a prescribed identical quantity printing, and distributes the print job to each of the plurality of image forming apparatuses in reverse proportion to the expected completion time answered from each of the plurality of image forming apparatuses.

### BRIEF DESCRIPTION OF THE DRAWINGS

These and other objects, advantages and features of the invention will become apparent from the following description thereof taken in conjunction with the accompanying drawings in which:

FIG. 1 is a block diagram showing the configuration of an image forming apparatus according to a preferred embodiment of the present invention;

FIG. 2 is an explanatory diagram showing comparatively the model data related to the hard disk drives of model A, model B, and model C;

FIG. 3 is an explanatory diagram showing an example of the look-up table stored by an image forming apparatus according to a preferred embodiment of the present invention;

FIG. 4 is an explanatory diagram showing a flow chart showing the operations related to the notifying of the expected completion time carried out at the time of inputting a job by an image forming apparatus according to a preferred embodiment of the present invention, and the equation for computing the expected completion time;

FIG. 5 is a flow chart showing an example of processing when the model data of the installed hard disk drive has not been stored in the flash memory;

FIG. 6 is a flow chart showing the processing when the expected completion time is updated during the execution of a job;

FIG. 7 is an explanatory diagram showing an example of the configuration of a printing system according to a second preferred embodiment of the present invention;

FIG. 8 is a block diagram showing the outline configuration of a printing control apparatus present in a printing system; and

FIG. 9 is a flow chart showing the processing carried out by the printing control apparatus at the time of a tandem printing request.

### DETAILED DESCRIPTION OF THE PREFERRED EMBODIMENTS

Some preferred embodiments of the present invention are described below referring to the drawings.

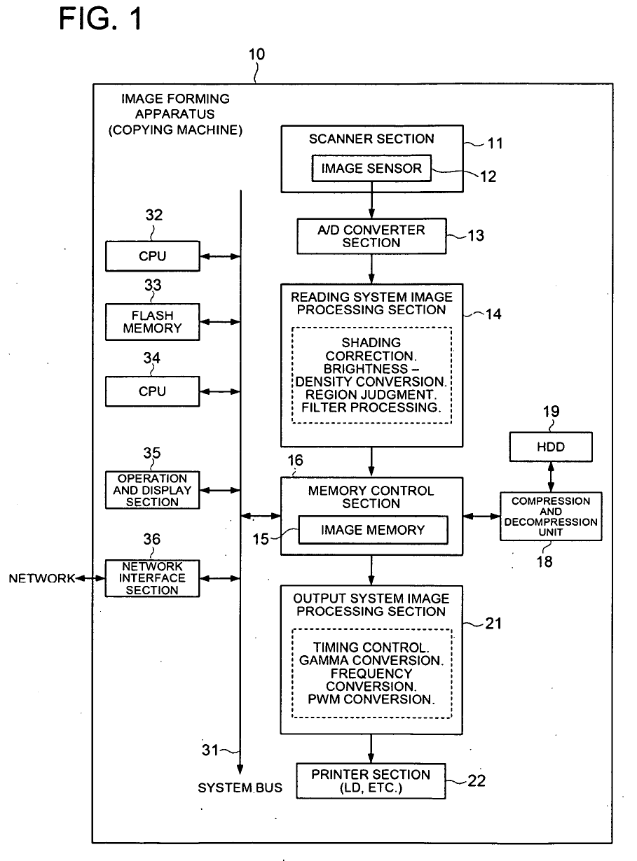

FIG. 1 is a block diagram showing the configuration of an image forming apparatus 10 according to a first preferred embodiment of the present invention. The image forming apparatus 10 is configured as a digital copying machine that is provided with a copying function, etc., for printing and outputting by forming copies of the images obtained by optically reading an original document on recording sheets.

The image forming apparatus 10 is provided with a scanner section 11 that reads out the original document, an A/D converter section 13 that quantizes the analog image data output by the image sensor 12 of the scanner section 11 and converts it into digital image data, a read system image processing section 14 that carries out various types of image processing on the digital image data output by the A/D converter section, a memory control section 16 that controls the reading and writing of data of the image memory 15, a compression and decompression unit 18 that compresses and decompresses image data, a hard disk drive (HDD) 19 as the storage device that stores the image data compressed by the compression and decompression unit 18 or the uncompressed image data, an output system image processing section 21 that carries out various data processing on the image data for carrying out print output, and a printing section 22 that prints out the image data on a recording sheet by image formation based on the image data from the output system image processing section 21. The hard disk drive 19 is connected under the compression and decompression unit 18.

Further, the image forming apparatus 10 is provided with a system bus 31 constituted by a PCI (Peripheral Component Interconnect) bus, etc., and to this system bus 31 are connected a CPU (Central Processing Unit) 32 that carries out the functions of comprehensively controlling that image forming apparatus 10, a flash memory 33 that stores the programs to be executed by the CPU 32 or the different types of data in a rewritable and nonvolatile manner, a RAM (Random Access Memory) 34 that is used and a work area for temporarily storing various types of data at the time that the CPU 32 executes the programs, an operation and display section 35, a network interface section 36, and said memory control section 16.

The operation and display section 35 is configured from a liquid crystal display provided with a touch panel on its surface and from various types of operation switches, and has the function of carrying out various types of guidance displays for the user or status displays and the function of receiving various types of operations from the user.

The network interface section 36 carries out the function of exchanging data with external apparatuses, by being connected to a network such as a LAN (Local Area Network). Further, the network interface section 36 receives, from an external terminal via the network, the print data made of character codes etc., and has the function of expanding that print data into image data, and has the function of an input section of image data similar to the scanner section 11.

The scanner section 11 has, in addition to an image sensor 12 that reads out the original document in units of a line, although not shown in FIG. 1, a light source that emits light onto the original document, a moving mechanism that moves the reading position of the image sensor 12 in units of a line along the length direction of the original document, and optical components made of lenses and mirrors, etc., that guide and converge the reflected light from the original document on to the image sensor 12. In addition, the scanner section 11 is provided with an automatic document feeder unit not shown in the Fig. for successively reading out a plurality of sheets of the original document successively and continuously.

The reading system image processing section 14 has the function of carrying out image processing such as shading correction, brightness-density conversion, region judgment, various types of filter processing (for example, magnification correction, gamma conversion, etc.), etc. on the image data input from the A/D converter section 13.

The memory control section 16 is provided with the function of managing and controlling the exchange of data between the reading system image processing section 14 and the image memory 15, the compression and decompression unit 18, the output system image processing section 21, and the system bus 31. In terms of details, it has the function of inputting the image data output from the reading system image processing section 14, the function of controlling the writing and reading of image data to and from the image memory 15 by giving the address signals and timing signals to the image memory 15, the function of exchanging data with the compression and decompression unit 18, the function of outputting the image data stored in the image memory 15 to the output system image processing section 21, and the function of exchanging image data or control data with the system bus 31, as well as other functions.

The output system image processing section 21 has the function of carrying out various image processing such as gamma conversion, frequency conversion, PWM conversion, etc. on the image data from the memory control section 16, and the timing control function of successively transmitting to the printer section 22 the image data in synchronization with the timing signal from the printer section 22.

The printer section 22 is one that forms and outputs images on a recording sheet by an electro-photographic process corresponding to the image data input from the output system image processing section 21, and although not shown in the Fig., it has the configuration of a so called laser printer having a recording sheet conveying apparatus, a photoreceptor drum, a charging unit, a laser unit, a developing unit, a transfer and separating unit, a cleaning unit, and a fixing unit. This can also be a printer of any other method.

The hard disk drive 19 has the SMART (Self-Monitoring Analysis and Reporting Technology) function which is a self diagnosis and reporting function. SMART is a technology for monitoring and reporting to the outside various information of the interior of the hard disk drive such as, the rate of generation of read errors, number of disk rotation retrials, temperature, etc. The CPU 32 obtains the temperature information of the hard disk drive 19 using the SMART function. Further, in case the hard disk drive 19 does not have a SMART function, etc. for notifying the internal temperature to the outside, it is possible to configure so that a separate temperature sensor is provided on the surface of or in the proximity of the hard disk drive 19, and the CPU 32 obtains the temperature information related to the hard disk drive from this temperature sensor.

In the following, the operation of the image forming apparatus 10 is explained taking the example of a copying job of copying an original document. When executing a copying job in the image forming apparatus 10, the image data obtained by reading the original document in the scanner section 11 is processed in the reading system image processing section 14, and after compression in the compression and decompression unit 18, or in the uncompressed state, the image data is stored temporarily in the hard disk drive 19. Next, this stored image data is successively read out from the hard disk drive, as is if it is uncompressed, or after decompressing in the compression and decompression unit 18 if it has been compressed, it is processed in the output system image processing section 21 and is applied to the printer section 22, whereby a copy image of the original document is printed out from the printer section 22.

In this manner, since the operation of writing image data to the hard disk drive 19 and the operation of reading out image data from the hard disk drive 19 are included in the processes for executing a copying job, the speed of writing data and the speed of reading out data in the hard disk drive 19 will have an effect on the copying speed.

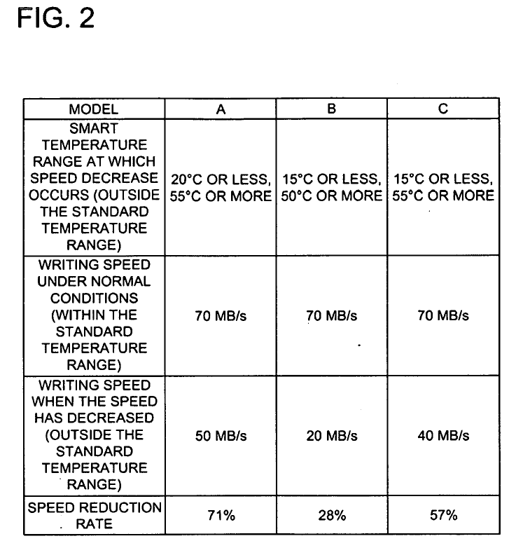

FIG. 2 is a table showing the relationship between temperature and the data writing speed in different types of hard disk drives 19. The temperature is the internal temperature of the hard disk drive obtained using the SMART function described earlier.

For example, in model A, while the writing speed (the normal writing speed) when the temperature T is within the standard temperature range of 20° C<T<55° C. is 70 MB/s, the writing speed gets reduced to 50 MB/s (the writing speed when the speed has decreased) when the temperature T is outside the standard temperature range (T≦20° C., T≧55° C.), and the rate of speed reduction is 71%. In model B, while the writing speed (the normal writing speed) when the temperature T is within the standard temperature range of 15° C.<T<50° C. is 70 MB/s, the writing speed gets reduced to 50 MB/s (the writing speed when the speed has decreased) when the temperature T is outside the standard temperature range (T≦15° C., T≧50° C.), and the rate of speed reduction is 28%. In this manner, depending on the model, the writing speed within the standard temperature range and the writing speed when the speed has decreased (the temperature characteristics of data writing speed) are varied.

In the flash memory of the image forming apparatus 10 is stored, the data indicating the temperature characteristics of the data writing speed, the data model name of hard disk drives, their standard temperature ranges, and the corresponding data writing speeds inside and outside the standard temperature ranges with correspondence established between them (this data is referred to hereinafter as the model data) for a plurality of models of hard disk drives that may be installed in that image forming apparatus 10. Further, in general, the data reading speed even at temperatures outside the standard temperature range does not differ from the normal reading speed.

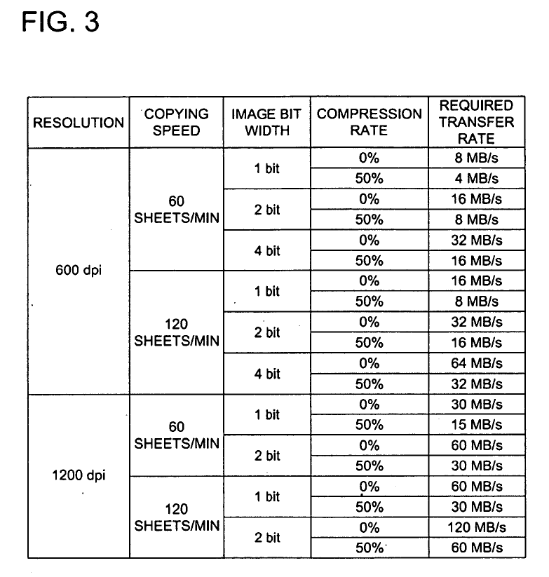

FIG. 3 shows an example of the look-up table 50 indicating the relationship between the operating conditions at the time of executing a copying job and the data transfer rate (required data transfer rate) of the hard disk drive 19 that is necessary for executing the copying job under those operating conditions. The required transfer rate of the look-up table 50 indicates the data transfer rate necessary when carrying out the operation of writing image data to the hard disk drive 19 and the operation of reading image data from the hard disk drive 19. The resolution is the resolution of reading out the original document, and the image bit width indicates the quantity of data per pixel. The image bit width is selected depending on the copying mode (for example, photograph mode, etc.). In general, as the image bit width is larger, images are obtained with a higher image quality. The compression rate is the ratio by which the compression and decompression unit 18 compresses the image data at the time the image data is stored in the hard disk drive 19. Here, 0% indicates that the image data is not compressed.

According to the look-up table 50, for example, the required data transfer rate is 32 MB/s under the operating conditions of a resolution of 600 dpi, a copying speed of 60 sheets/minute, an image bit width of 4 bits, and a compression rate of 0%. Further, the required data transfer rate is 30 MB/s under the operating conditions of a resolution of 1200 dpi, a copying speed of 60 sheets/minute, an image bit width of 2 bits, and a compression rate of 50%. The required transfer rate expected of the hard disk drive 19 changes in this manner depending on the operating conditions such as the resolution, etc. In view of this, the required transfer rate is computed in advance for different operating conditions thereby preparing a look-up table which is then stored in the flash memory 33. Further, the operating conditions of a resolution of 1200 dpi, a copying speed of 120 sheets/minute, an image bit width of 2 bits, and a compression rate of 0% is not actually used because it exceeds the maximum writing speed of 70 MB/s of a hard disk drive conforming to the SATA standards.

Next, the function of notifying the expected completion time of a copying job is explained below.

If the internal temperature of the hard disk drive 19 goes outside the standard temperature range of that hard disk drive 19, as is shown in FIG. 2, the data writing speed becomes lower than normal. Therefore, because of its effect, if the required transfer rate cannot be satisfied, the number of copies per unit time becomes lower than the usual rate. Therefore, the image forming apparatus 10 is provided with the function of calculating and notifying to the user the expected completion time which is the time required until that job is completed.

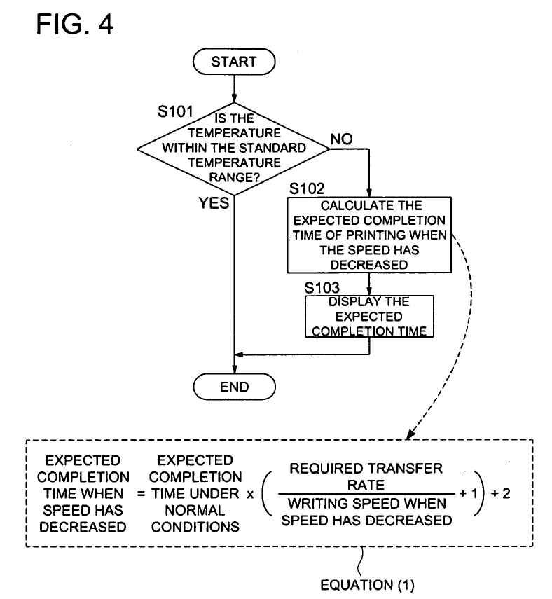

FIG. 4 is a flow chart showing the operations of the image forming apparatus related to the notifying of the expected completion time. The CPU 32 of the image forming apparatus 10, when a copying job is input, not only obtains from the flash memory 33 the model data (the standard temperature range, the writing speed when the speed has decreased, etc.) corresponding to the model of the hard disk drive 19 that has been installed in that image forming apparatus 10, but also obtains the temperature of the hard disk drive 19 using the SMART function, and determines if that temperature is within the standard temperature range (Step S101).

Further, it is also possible to have a configuration in which the model of the hard disk drive 19 is checked at the time the power to the image forming apparatus 10 is switched ON, reading out the model data corresponding to that model from the flash memory 33, and storing it in the RAM 34, and the standard temperature range, the writing speed when the speed has decreased, etc. are obtained from this data in the RAM 34.

If the obtained temperature of the hard disk drive 19 is not within that standard temperature range (NO in Step S101), the expected completion time when the speed has decreased is calculated (Step S102), and the obtained expected completion time is displayed in the operation and display section 35 (Step S103).

For example, when the hard disk drive 19 is model B of FIG. 2, the writing speed outside the standard temperature range will be 20 MB/s. If the required data transfer rate is 60 MB/s for the operating conditions of that copying job, the time required for writing data at a temperature outside the standard temperature range will be 3 times the time required under normal conditions (when the temperature is within the standard temperature range). On the other hand, the reading speed does not decrease even when the temperature is outside the standard temperature range. Therefore, the expected completion time of the copying job will twice the time as under normal conditions.

In general, the expected completion time is obtained using the equation shown in the bottom part of FIG. 4. Here, the required transfer rate is obtained by referring to the look-up table 50 according to the operating conditions of that copying job (the parameter values of the resolution, copying speed under normal conditions, image bit width, compression rate, etc.). The writing speed when the writing speed has decreased is obtained from the model data. The expected completion time under normal conditions is obtained using any optional method. For example, the number of sheets processed per unit time (for example, number sheets processed per minute) under normal conditions is stored for each set of operating conditions of a copying job, and the expected completion time is obtained by dividing the number of copies set in that copying job by the number of sheets processed.

Further, the expected completion time can be expressed concretely as the length of time such as XX minutes and YY seconds, or it can be expressed as a multiplication factor relative to the time required under normal conditions. For example, in the above example, it is also possible to have a configuration in which a message such as “At the current temperature, it takes twice the time until the copying job is completed” is displayed in the operation and display section 35.

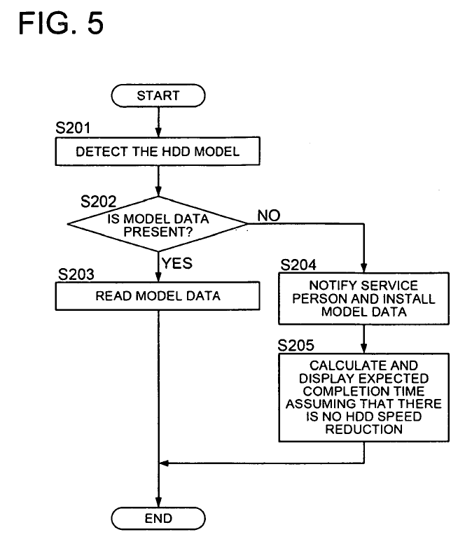

FIG. 5 is an example of the processing corresponding to the case when the model data of the hard disk drive 19 that has been installed has not been stored in the flash memory 33. The CPU 32 detects the model of the hard disk drive 19 (Step S201), and checks whether or not the model data for this model has been stored in the flash memory 33 (Step S202). If it has been stored (YES in Step S202), the corresponding model data is read out (Step S203), and the processing shown in FIG. 4 are carried out using this model data.

If the model data for the detected model has not been stored in the flash memory 33 (NO in Step S202), this fact is informed to the servicing person thereby asking that servicing person to install (store) the model data for that model in the flash memory 33 (Step S204). Next, for the present case, the expected completion time is calculated assuming that there is no reduction in speed (that is, the expected completion time under normal conditions), and this is displayed in the operation and display section 35 (Step S205). For example, it is possible to display a message in the operation and display section 35 asking the user to inform the service personnel, or to send an email with the contents of this notifying to an address that has been registered in advance. Further, installing the model data of a new model in the flash memory 33 is done either via a network such as the Internet, or by reading it in from a USB (Universal Serial Bus) memory or a CD-ROM (Compact Disk Read Only Memory), etc.

Next, the operations are explained in a case in which a copy job with a large number of sheets or a large number of sets has been reserved. When a copy job with a large number of sheets or a large number of sets has been reserved, it is likely that the internal temperature of the hard disk increases in the middle of job execution, and the expected completion time of the job varies in the middle of job execution. In view of this, when a copy job with more than a prescribed number of sheets or with more than a prescribed number of sets has been reserved, the internal temperature of the hard disk drive 19 is monitored at appropriate times during job execution using the SMART function, the expected completion time of the job is calculated and the display is updated.

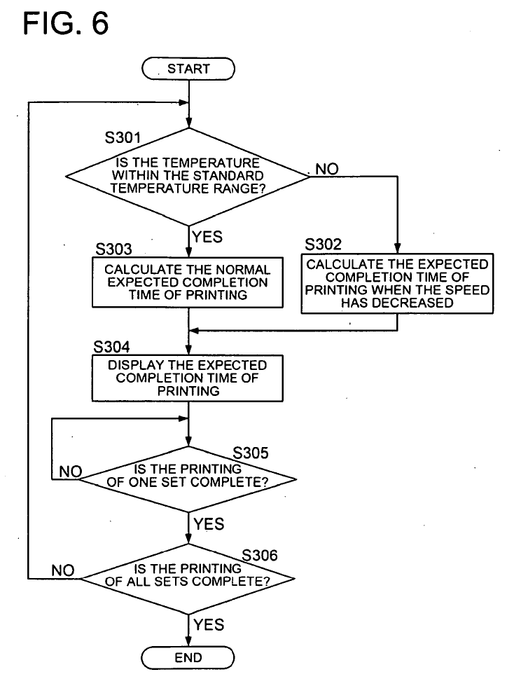

This flow is shown in FIG. 6. At the time the job is input, the internal temperature of the hard disk drive 19 is obtained using the SMART function, and a judgment is made as to whether or not this temperature is within the standard temperature range (Step S301). Next, if the temperature inside the hard disk drive 19 is outside the standard temperature range (NO in Step S301), the expected completion time when the speed has been reduced is calculated (Step S302), and this is displayed in the operation and display section 35 (Step S304). On the other hand, if the temperature inside the hard disk drive 19 is within the standard temperature range (YES in Step S301), the normal expected completion time is calculated (Step S303), and this is displayed in the operation and display section 35 (Step S304).

After that, when the printing of one set of copies or when the printing of a prescribed number of sheets has been completed (YES in Step S305) and also if the printing of all the sets of copies or of all the sheets has not been completed (NO in Step S306), the operation returns again to Step S301, the internal temperature of the hard disk drive 19 is obtained using the SMART function, the expected completion time is calculated according to whether or not this temperature is within the standard temperature range, and this time displayed in the operation and display section 35 is updated.

Further, in Step S302, the expected completion time when the speed has decreased is calculated for the remaining number of sets of copies or the remaining number of sheets, and in Step S303, the expected completion time under normal conditions is calculated for the remaining number of sets of copies or the remaining number of sheets.

Next, as a second preferred embodiment of the present invention, a printing system to which the image forming apparatus 10 has been applied is described below.

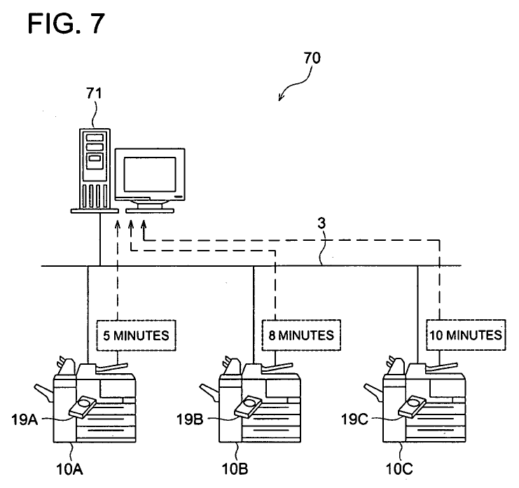

FIG. 7 shows an example of the configuration of a printing system. The printing system 70 has a plurality of image forming apparatuses 10A, 10B, and 10C, and a printing control apparatus 71 connected via a network 3 such as a LAN, etc. The printing control apparatus 71 has the function of executing a single print job by dividing it among the plurality of image forming apparatuses 10A, 10B, and 10C (that is, the function of carrying out the so called tandem printing).

In this example, although the image forming apparatuses 10A, 10B, and 10C are all of the same type, the models of the hard disk drives installed in them are all different. Model A hard disk drive 19 is installed in the image forming apparatus 10A, model B hard disk drive 19 is installed in the image forming apparatus 10B, and model C hard disk drive 19 is installed in the image forming apparatus 10C.

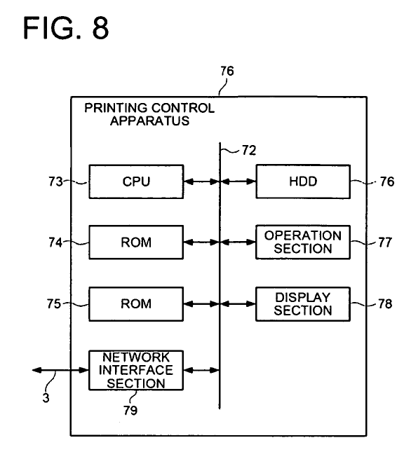

FIG. 8 shows an outline configuration of the printing control apparatus 71. The printing control apparatus 71 is configured to have a CPU 73 that comprehensively controls the operations of that printing control apparatus 71, a ROM 74 that stores the programs executed by the CPU 73 and various types of data, a RAM 75 which is used as the work area for temporarily storing various types of data at the time the CPU 73 executes the programs, a hard disk drive (HDD) 76 that stores the application programs, etc., an operation section 77 such as a keyboard, mouse, etc. that accepts operations by the user, a display section 78 such as a liquid crystal display, etc., and a network interface section 79 for communicating with an external apparatus such as an image forming apparatus 10 via a network 3, which are connected via a bus 72.

The image forming apparatuses 10A, 10B, and 10C have almost the same configuration as that of the image forming apparatus 10 shown in FIG. 1, and apart from having the same functions, when they receive an inquiry from the printing control apparatus 71 about the expected completion time of a print job with a prescribed quantity (for example, 100 sheets), they have the function of finding out the temperature of the hard disk drive 19 at that point in time, calculating the expected completion time of the print job according to that temperature, and responding (returning) that time to the printing control apparatus 71.

The image forming apparatuses 10A, 10B, and 10C are storing in the flash memory 33 a look-up table for print jobs that functions in the same manner as the look-up table 50 of FIG. 3 in a copying job. In detailed terms, the required transfer rate for each set of operating conditions (resolution, image bit width, etc.) of the print job are stored in advance in the look-up table for print jobs, and the expected completion time of a print job is calculated by substituting the required transfer rate obtained from this look-up table in Equation (1).

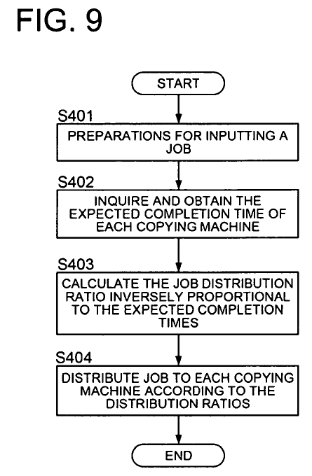

Event though the image forming apparatuses 10A, 10B, and 10C are of the same model as a copying machine, the models 19A, 19B, and 19C of the hard disk drives installed in them are all different, and there are differences among them in the standard temperature range in which the data writing speed does not decrease, the writing speed outside the standard temperature range (the writing speed when the speed had decreased). Because of this, for example, there may be differences in productivity due to low temperatures, and it will not be efficient if tandem printing is made by uniformly distributing a job among them under such conditions. Therefore, the printing control apparatus 71 orders tandem printing while determining the rate of distribution among them according to the procedures shown in FIG. 9.

In other words, when the preparations for inputting a job are completed after setting the print data or the number of sheets to be printed out, etc. (Steps S401), the printing control apparatus 71 inquires and obtains the expected completion time for printing a certain unit number of sheets (for example, 100 sheets) from each of the image forming apparatuses 10A, 10B, and 10C (Step S402). The printing control apparatus 71 calculates the distribution ratios for the print job so that they are inversely proportional to the obtained expected completion times (Step S403), and orders printing to (inputs jobs in) the image forming apparatuses 10A, 10B, and 10C by distributing the print job among them according to these distribution ratios (Step S404).

Further, it is also possible to inquire the expected completion time for executing the current entire print job in one image forming apparatus, or else, it is possible to inquire the expected completion for executing when the current print job is uniformly distributed among the image forming apparatuses 10A, 10B, and 10C, and if the expected completion time is inquired for the same quantity (number of printed sheets), that same quantity can by any quantity.

In response to the inquiry of the expected completion time, if, for example, a response of 5 minutes is received from the image forming apparatus 10A, a response of 8 minutes from the image forming apparatus B, and a response of 10 minutes is received from the image forming apparatus 10C, the distribution ratio A for the image forming apparatus A, the distribution ratio B for the image forming apparatus B, and the distribution ratio C for the image forming apparatus C will be, (1/5):(1/8):(1/10)=8:5:4. If the total number of pages of this print job is 170 sheets, then the printing control apparatus 71 carries out tandem printing by ordering 80 pages to the image forming apparatus 10A, 50 pages to the image forming apparatus 10B, and 40 pages to the image forming apparatus 10C.

In this manner, since the job is distributed inversely proportional to the expected completion time obtained by inquiring each of the image forming apparatuses 10A, 10B, and 10C, even if there are variations in the productivities due to low temperatures among the different image forming apparatuses 10A, 10B, and 10C, since the print job is distributed among them according to the respective productivities, it is possible to execute tandem printing efficiently so that the job is completed in a short time.

In the above, although some preferred embodiments of the present invention have been described referring to the drawings, the concrete configurations need not be limited to those shown in the preferred embodiments, but any modifications or additions within the scope and intent of the present invention shall be included in the present invention.

For example, it is possible to obtain the temperature of a hard disk drive 19 using a method other than using the SMART function. Further, although the explanations were given for the example of a copy job in the first preferred embodiment, this can also be applied to a job in which the operation is that of storing the input image data in the hard disk drive 19, and printing it while reading it out from the hard disk. For example, when executing a print job with the flow of receiving the print data from an external terminal via a network, and while expanding this into image data and storing it in the hard disk drive 19, this image data is read from the hard disk drive 19 and printed out in the printer section 22, this print job can become a target for the calculation and display of the estimated completion time according to the present invention. Further, in the case of a print job, it is also possible to have a configuration in which the information indicating the expected completion time is transmitted to the external terminal asking for the execution of that print job, and displaying the expected completion time in the display screen of the external terminal (for example, the screen of the printer driver).

Further, although the expected completion time was calculated using Equation (1) in the preferred embodiments, it is sufficient to prepare an equation according to the flow of data and obtain the expected completion time from that equation, and it is not necessary to be restricted to Equation (1). For example, when copying several sets, since the operation of reading out the document associated with the operation of writing data in the hard disk drive 19 is only once, it is sufficient to use an equation for calculation according to that.

Further, although the explanations given were for the example of a hard disk drive, it is possible that there is some other type of storage device as long as it is a storage device in which the data writing speed and the data reading speed decrease when the temperature is outside a standard temperature range. In addition, when the reading speed changes according to the temperature, it is possible to store as the model data the data indicating the temperature characteristics of the reading speed, and to calculate the expected completion time considering both the reduction in the writing speed and the reduction in the reading speed.

The image forming apparatus 10 is not limited to a copying machine, but can be a multifunction unit having a facsimile function, etc., or can be a printer, or any apparatus that temporarily stores the input data in an image forming apparatus 10 and prints it out.

In the above invention, the temperature is obtained of a storage device such as a hard disk drive, and the expected completion time of that job is calculated and notified to the user if the print job is executed at the writing speed at that temperature. For example, if the writing speed of the storage device decreases due to low temperatures, the expected completion time of the job is calculated and notified to the user if the job is executed under those conditions.

In the above invention, in the case of large volume printing, since it is possible that the temperature of the storage device changes to outside or inside the standard temperature range during the execution of the job, by updating the expected completion time in the middle of job execution, a more accurate expected completion time is notified to the user.

In the above invention, it is possible to execute tandem printing by distributing the job efficiently.

According to an image forming apparatus of the present invention, even when longer than normal time is taken until the end of a print job due to reduction in the data writing speed of the storage device, the user is not subjected to unexpected inconveniences.

What is claimed is:

1. An image forming apparatus for storing input image data in a storage device, and executing a print job by reading out the image data from the storage device, comprising:
a temperature acquiring section which obtains the temperature of the storage device;
a calculation section which calculates the expected, completion time of the print job according to a data writing speed of the storage device at the temperature obtained by the temperature acquiring section; and
a notifying section which notifies to a user the expected completion time calculated by the calculation section.

2. The image forming apparatus of claim 1, wherein the calculation section calculates the expected completion time of the print job at the temperature, from the expected completion time of a case where the print job is executed at a highest speed, a required writing speed of the storage device necessary for executing the print job at the highest speed, and the writing speed of the storage device at the temperature obtained by the temperature acquiring section.

3. The image forming apparatus of claim 1, wherein the expected completion time notified by the notifying section is updated during the execution of the print job.

4. The image forming apparatus of claim 1, further comprising a model data storing section which stores model data of a plurality of storage devices, the model data indicating temperature characteristics of data writing speed of the storage device, wherein the calculation section calculates the expected completion time based on the model data, obtained from the model data storing section, of the storage device installed in the image forming apparatus.

5. The image forming apparatus of claim 4, further comprising a data updating section which updates the model data stored in the model data storing section.

6. An image forming apparatus of claim 1, wherein the storage device is a hard disk drive provided with a SMART (Self-Monitoring Analysis and Reporting Technology) function, and the temperature acquiring section obtains the temperature of the hard disk drive by the SMART function.

7. A printing system comprising a plurality of image forming apparatuses each of which stores input image data in a storage device and executes print jobs by reading out the image data from the storage device; and a printing control apparatus which causes the plurality of image forming apparatuses to execute a single print job by sharing the single print job with the plurality of image forming apparatus, wherein each of the image forming apparatuses comprises:
a temperature acquiring section which obtains the temperature of the storage device;
a calculation section which calculates the expected completion time of the print job according to a data writing speed of the storage device at the temperature obtained by the temperature acquiring section; and
a notifying section which notifies to a user the expected completion time calculated by the calculation section,
wherein the printing control apparatus inquires to each of the plurality of image forming apparatuses about the expected completion time in a case of executing a prescribed identical quantity printing, and distributes the print job to each of the plurality of image forming apparatuses in reverse proportion to the expected completion time answered from each of the plurality of image forming apparatuses.

8. The printing system of claim 7, wherein the calculation section calculates the expected completion time of the print job at the temperature, from the expected completion time of a case where the print job is executed at a highest speed, a required writing speed of the storage device necessary for executing the print job at the highest speed, and the writing speed of the storage device at the temperature obtained by the temperature acquiring section.

9. The printing system of claim 7, wherein the expected completion time notified by the notifying section is updated during the execution of the print job.

10. The printing system of claim 7, wherein each of the plurality of image forming apparatuses further comprises a model data storing section which stores model data of a plurality of storage devices, the model data indicating temperature characteristics of data writing speed of the storage device, wherein the calculation section calculates the expected completion time based on the model data, obtained from the model data storing section, of the storage device installed in each of the plurality of image forming apparatuses.

11. The printing system of claim 10, wherein each of the plurality of image forming system further comprises a data updating section which updates the model data stored in the model data storing section.

12. The printing system of claim 7, wherein the storage device is a hard disk drive provided with a SMART (Self-Monitoring Analysis and Reporting Technology) function, and the temperature acquiring section obtains the temperature of the hard disk drive by the SMART function.
